(19) United States
(12) Patent Application Publication
(10) Pub. No.: US 2026/0267156 A1
(43) Pub. Date: Sep. 10, 2026

(54) POLARIZATION BEAM SPLITTING APPARATUS, LIGHT SOURCE APPARATUS, DISPLAY APPARATUS, AND ILLUMINATION APPARATUS

(71) Applicant: CANON KABUSHIKI KAISHA, Tokyo (JP)

(72) Inventor: Yuuki MAEDA, Tochigi (JP)

(21) Appl. No.: 19/450,827

(22) Filed: Jan. 16, 2026

(30) Foreign Application Priority Data
Jan. 29, 2025 (JP) 2025-012524

(51) Int. Cl. G02B 27/10; F21V 8/00; G02B 27/01; G02B 27/14; G02B 27/28; G02F 1/13357; G03B 21/20

(52) U.S. Cl. CPC G02B 27/106; G02B 6/003; G02B 6/0056; G02B 27/0101; G02B 27/142; G02B 27/144; G02B 27/145; G02B 27/285; G02F 1/13362; G03B 21/2073

(57) ABSTRACT

A polarization beam splitting apparatus may be configured to split light from a light source and emit a plurality of polarized lights and may include a plurality of optical surfaces including a first optical surface, a second optical surface, and a third optical surface. The first optical surface is disposed closer to an incident portion of the light on the polarization beam splitting apparatus than the second optical surface. The second optical surface is disposed closer to the incident portion than the third optical surface. Predetermined inequalities are satisfied.

### BACKGROUND

### Field of the Technology

The present disclosure relates to a polarization beam splitting apparatus, a light source apparatus, a display apparatus, and an illumination apparatus.

### Description of the Related Art

Japanese Patent Application Laid-Open No. 2018-116261 discloses a head-mounted display (HMD) device in which a light beam from a light source is split by a half-transmissive reflective surface and emitted.

### SUMMARY

A polarization beam splitting apparatus according to one aspect of the present disclosure is configured to split light from a light source and emit a plurality of polarized lights. The polarization beam splitting apparatus includes a plurality of optical surfaces including a first optical surface, a second optical surface, and a third optical surface. The first optical surface is disposed closer to an incident portion of the light on the polarization beam splitting apparatus than the second optical surface. The second optical surface is disposed closer to the incident portion than the third optical surface. The following inequalities are satisfied:

$$5 \leq TP 1 \leq 75$$

$$RS 1 \geq 75$$

where TP1 is a transmittance (%) of a dominant wavelength of polarized light polarized in a first direction on the first optical surface, and RS1 is a reflectance (%) of the dominant wavelength of polarized light polarized in a second direction on the first optical surface. A light source apparatus and a display apparatus each having the above polarization beam splitting apparatus also constitute another aspect of the present disclosure.

One or more embodiments of a light source apparatus according to one or more aspects of the present disclosure may include a light source, and a polarization beam splitting unit configured to split light from the light source and emit a plurality of polarized lights. The polarization beam splitting unit has a plurality of optical surfaces including a first optical surface, a second optical surface, and a third optical surface. The first optical surface is disposed closer to an incident portion of the light on the polarization beam splitting unit than the second optical surface. The second optical surface is disposed closer to the incident portion than the third optical surface. The following inequalities are satisfied:

$$5 \leq TP 1 \leq 75$$

$$RS 1 \geq 75$$

where TP1 is a transmittance (%) of a dominant wavelength of polarized light polarized in a first direction on the first optical surface, and RS1 is a reflectance (%) of the dominant wavelength of polarized light polarized in a second direction on the first optical surface. A display apparatus having the above light source apparatus also constitutes another aspect of the present disclosure. A polarization beam splitting apparatus corresponding to the above polarization beam splitting unit also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a light source apparatus according to Example 1.

FIGS. 2A, 2B, 2C, and 2D illustrate a film characteristic of optical surfaces of a polarization beam splitting unit according to Example 1.

FIGS. 3A and 3B are configuration diagrams of a display apparatus according to Example 1.

FIGS. 4A and 4B are configuration diagrams of an illumination system according to Example 1.

FIG. 5 is a configuration diagram of a light source apparatus according to Example 2.

FIG. 6 is a configuration diagram of a light source apparatus according to Example 3.

FIG. 7 is a configuration diagram of a light source apparatus according to Example 4.

FIG. 8 is a configuration diagram of a light source apparatus according to Example 5.

### DESCRIPTION OF THE EMBODIMENTS

Referring now to the accompanying drawings, a detailed description will be given of examples according to the present disclosure. Corresponding elements in respective figures will be designated by the same reference numerals, and a duplicate description thereof will be omitted.

### Example 1

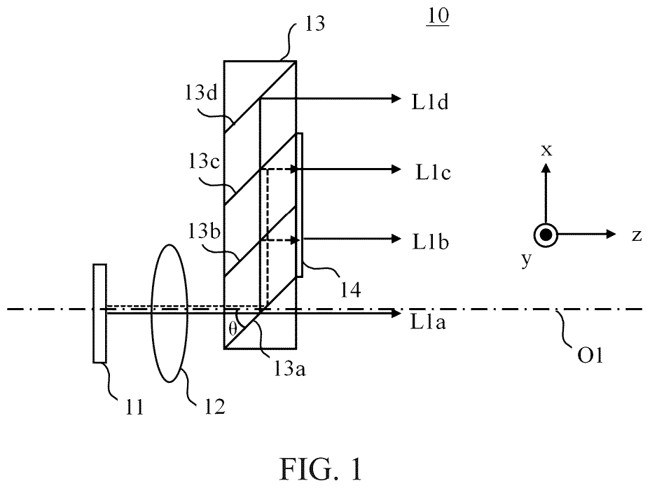

Referring now to FIG. 1, a light source apparatus 10 according to Example 1 of the present disclosure will be described. FIG. 1 is a structural diagram of the light source apparatus 10. The light source apparatus 10 includes a light source 11, an optical system 12, a polarization beam splitting unit (polarization beam splitting apparatus) 13, and a half-wave plate (phase plate) 14. The light source 11 is a light source such as an organic light-emitting diode (OLED), a light-emitting diode (LED), a laser, or a mercury lamp. A light beam emitted from the light source 11 enters the polarization beam splitting unit 13 via the optical system 12, which includes one or more lenses. The optical system 12 is disposed between the light source 11 and the polarization beam splitting unit 13.

The polarization beam splitting unit 13 splits the light (light beam) from the light source 11 and emits a plurality of polarized lights (a plurality of light beams). The polarization beam splitting unit 13 has a plurality of optical surfaces, including a first optical surface (first polarizing mirror) 13a, a second optical surface (second polarizing mirror) 13b, a third optical surface (polarization beam splitter) 13c, and a fourth optical surface (mirror) 13d. The first optical surface 13a is disposed closer to the light incident portion than the second optical surface 13b. The second optical surface 13b is disposed closer to the light incident portion than the third optical surface 13c. The third optical surface 13c is disposed closer to the light incident portion than the fourth optical surface 13d.

The first optical surface 13a has the characteristic of transmitting 50% of P-polarized light (polarized light polarized in a first direction) (reflecting 50% of P-polarized light) and reflecting 100% of S-polarized light (polarized light polarized in a second direction). The second optical surface 13b has the characteristic of transmitting 100% of P-polarized light and reflecting 50% of S-polarized light (transmitting 50% of S-polarized light). The third optical surface 13c transmits 100% of P-polarized light and reflects 100% of S-polarized light. The fourth optical surface 13d reflects 100% of P-polarized light. Thus, the first and second polarizing mirrors may not have 0% or 100% transmittance for P-polarized light or S-polarized light, respectively. The polarization beam splitter has 0% transmittance for S-polarized light and 100% transmittance for P-polarized light. In this example, P-polarized light is polarized light polarized in the x-direction (first direction), and S-polarized light is polarized light polarized in the y-direction (second direction).

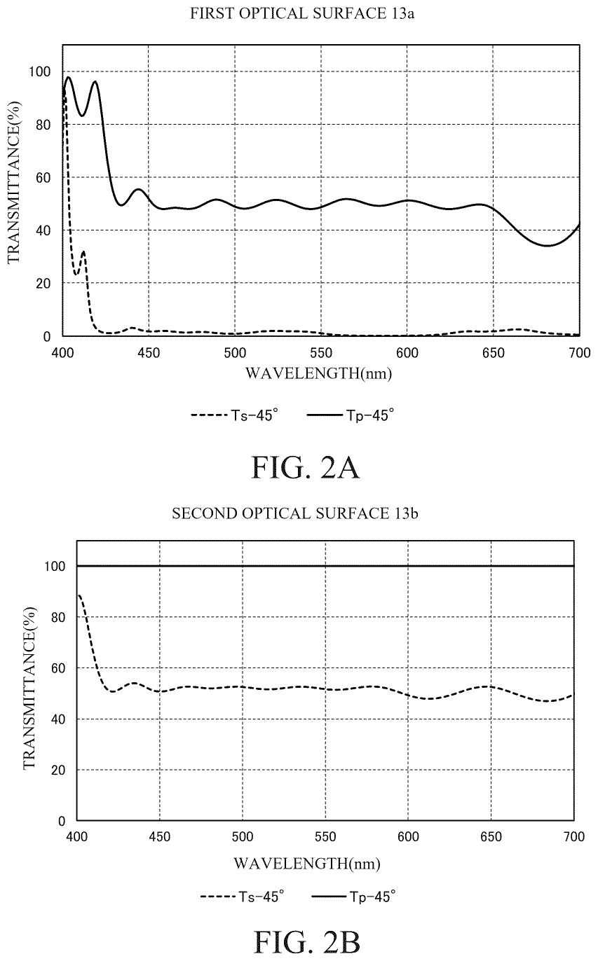

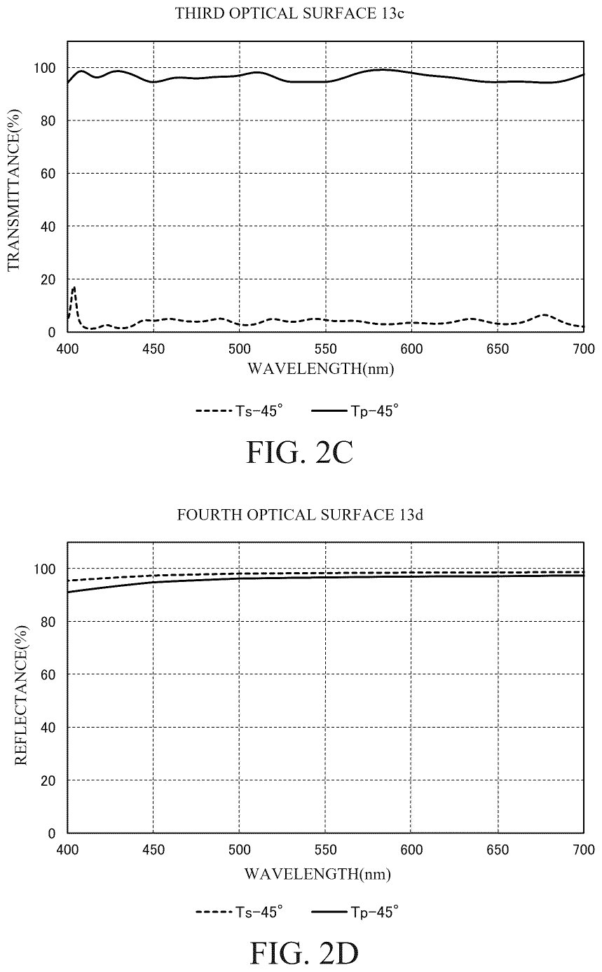

The above characteristics of each optical surface are ideal. In reality, each optical surface is made of a dielectric or metal film, and the actual characteristics often deviate from the ideal. The film characteristics of the first optical surface 13a, second optical surface 13b, third optical surface 13c, and fourth optical surface 13d are described with reference to FIGS. 2A, 2B, 2C, and 2D. FIGS. 2A, 2B, 2C, and 2D illustrate the film characteristics of the first optical surface 13a, the second optical surface 13b, the third optical surface 13c, and the fourth optical surface 13d, respectively. In FIGS. 2A, 2B, and 2C, the horizontal axis represents wavelength (nm) and the vertical axis represents transmittance (%). In FIG. 2D, the horizontal axis represents wavelength (nm) and the vertical axis represents reflectance (%).

In this example, each of the first optical surface 13a, the second optical surface 13b, and the third optical surface includes a dielectric multilayer film, and the fourth optical surface 13d includes a metal film. Each optical surface may include a dielectric multilayer film, a metal film, a wire grid, or a metasurface. Alternatively, each optical surface may include a hybrid film that combines a dielectric film and a metal film. The fourth optical surface 13d may reflect light by total internal reflection.

In this example, the glass material of the waveguide of the polarization beam splitting unit 13 is, for example, S-BSL7 (OHARA), but is not limited to this example. The waveguide may also be made of plastic as long as it is a transparent material.

The light beam incident on the polarization beam splitting unit 13 is split (separated) into a plurality of light beams (light rays) L1a, L1b, L1c, and L1d, which are emitted as predetermined polarized light. The light beams L1a and L1d are emitted as P-polarized light. The light beams L1b and L1c are emitted as S-polarized light and are converted to P-polarized light by the half-wave plate 14. They are emitted from the light source apparatus 10 as P-polarized light that has been magnified four times. The half-wave plate 14 may be placed on the exit side of light beams L1a and L1d to emit them as S-polarized light. A polarizing plate or the like may be placed on the exit side of the half-wave plate 14 to increase the degree of polarization.

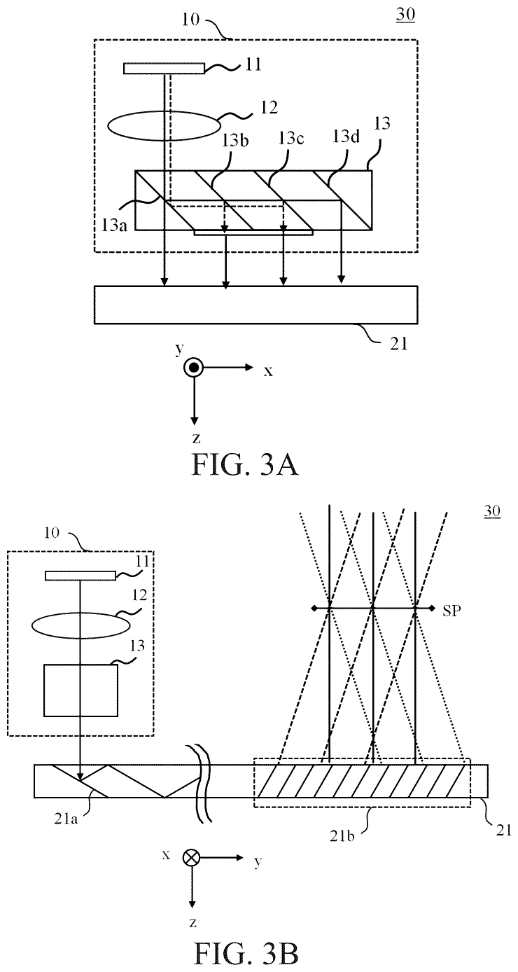

Next, the display apparatus 30 according to this example will be described with reference to FIGS. 3A and 3B. FIGS. 3A and 3B are structural diagrams of the display apparatus 30. FIG. 3A illustrates the display apparatus 30 viewed from the y direction, and FIG. 3B illustrates the display apparatus 30 viewed from the x direction. The display apparatus 30 has a light guide plate (light guide element) 21. The light guide plate 21 has an incident portion 21a where light from the light source 11 enters, and an exit portion 21b from which the light exits.

The light source 11 of the light source apparatus 10 is a light source that emits image light. The image light is a light beam emitted from a display element such as an OLED or LCD panel. In this example, the light source 11 is an OLED light source that emits image light in the blue band (dominant wavelength 450 nm), green band (dominant wavelength 520 nm), and red band (640 nm), but is not limited to this example.

The light beam emitted from the light source 11 (light from the light source 11) enters the polarization beam splitting unit 13 via the optical system 12 and is emitted from the light source apparatus 10 as a P-polarized light beam (P-polarized light). The P-polarized light emitted from the light source apparatus 10 enters the incident portion 21a. The light beam reflected by the incident portion 21a propagates within the light guide plate 21 by total reflection and is split into a plurality of light beams by the exit portion 21b, which are emitted to the pupil SP. The incident portion 21a has a reflective surface, and the exit portion 21b has a plurality of transmissive reflective surfaces. The incident portion 21a and the exit portion 21b may also use diffraction gratings, metasurfaces, or hologram elements.

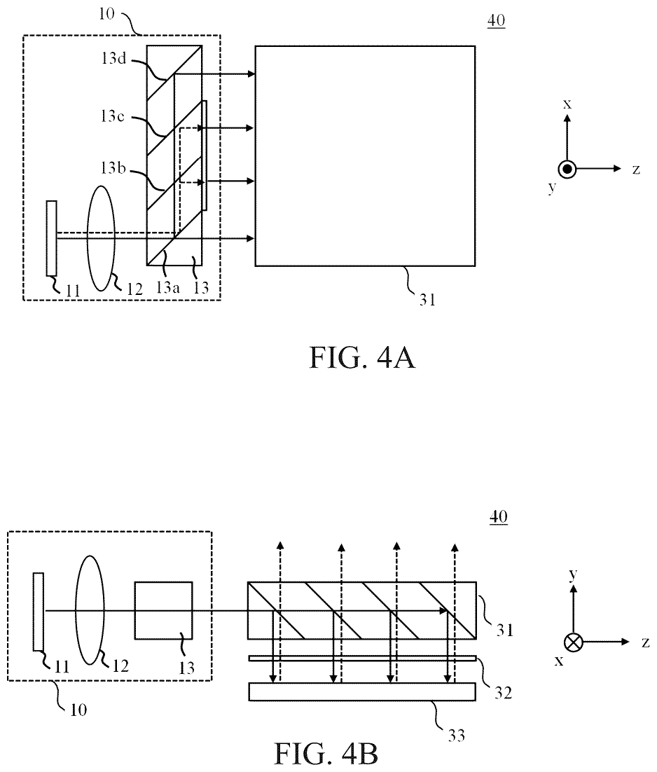

Next, the illumination system 40 in this example will be described with reference to FIGS. 4A and 4B. FIGS. 4A and 4B are configuration diagrams of the illumination system. FIG. 4A illustrates the illumination system 40 viewed from the y direction, and FIG. 4B illustrates the illumination system 40 viewed from the x direction.

The illumination system 40 includes a light source apparatus 10 and a second polarization beam splitting unit 31, and illuminates a liquid crystal panel 33. The light source 11 of the light source apparatus 10 is an LED, laser, mercury lamp, etc. The divergent light beam emitted from the light source 11 is collimated by the optical system 12 and emitted as a plurality of light beams of P-polarized light (polarized in the x-direction) by the polarization beam splitting unit 13.

The P-polarized light emitted from the light source apparatus 10 is split into a plurality of light beams by the second polarization beam splitting unit 31 and emitted via the quarter-wave plate 32, illuminating the liquid crystal panel 33. The light beam modulated by the liquid crystal panel 33 passes through the second polarization beam splitting unit 31 and is emitted from the illumination system 40. The illumination system 40 is used in a projector that projects the light beam emitted from the illumination system 40 onto an illuminated surface via a projection system (not illustrated). The illumination system 40 may be applied to Augmented Reality (AR) glasses that project onto the pupil via an optical system and a light guide plate. Alternatively, the illumination system 40 may be applied to HMDs such as Virtual Reality (VR) or Mixed Reality (MR) that project onto the pupil via an optical system.

Inequalities in this example will be described below. The following inequalities described in this example are also applicable to the examples described later.

The following inequalities (1) and (2) may be satisfied:

$$5 \leq TP 1 \leq 75 \qquad ( 1 )$$

$$RS 1 \geq 75 \qquad ( 2 )$$

where TP1 is a transmittance (%) of the dominant wavelength of polarized light polarized in a first direction (P-polarized light) on the first optical surface 13a, and RS1 is a reflectance (%) of the dominant wavelength of polarized light polarized in a second direction (S-polarized light) on the first optical surface 13a.

In a case where TP1 becomes higher than the upper limit of inequality (1), the relative light intensity of the light beam L1a increases. On the other hand, in a case where TP1 becomes lower than the lower limit of inequality (1), the relative light intensity reduces and a light amount distribution of the light beam emitted from the polarization beam splitting unit 13 becomes non-uniform. In a case where RS1 becomes lower than the lower limit of inequality (2), unnecessary polarized light is emitted from the light beam L1a, and the light utilization efficiency reduces.

Inequalities (1) and (2) may be replaced with inequalities (1a) and (2a) below:

$$7 \leq T P 1 \leq 65 \qquad ( 1 a )$$

$$RS 1 \geq 85 \qquad ( 2 a )$$

Inequalities (1) and (2) may be replaced with inequalities (1b) and (2b) below:

$$9 \leq TP 1 \leq 60 \qquad ( 1 b )$$

$$RS 1 \geq 90 \qquad ( 2 b )$$

The following inequalities (3) and (4) may be satisfied:

$$5 \leq RS 2 \leq 75 \qquad ( 3 )$$

$$TP 2 \geq 75 \qquad ( 4 )$$

where TP2 is a transmittance (%) of the dominant wavelength of polarized light polarized in a first direction (P-polarized light) on the second optical surface 13b, and RS2 is a reflectance (%) of the dominant wavelength of polarized light polarized in a second direction (S-polarized light) on the second optical surface 13b.

In a case where RS2 becomes higher than the upper limit of inequality (3), the relative light intensity of light beam L1b increases. On the other hand, in a case where RS2 becomes lower than the lower limit of inequality (3), the relative light intensity reduces and a light amount distribution of the light beam emitted from the polarization beam splitting unit 13 becomes non-uniform. In a case where TP2 becomes lower than the lower limit of inequality (4), unnecessary polarized light is emitted from light beam L1b and the light utilization efficiency reduces.

Inequalities (3) and (4) may be replaced with inequalities (3a) and (4a) below:

$$7 \leq RS 2 \leq 65 \qquad ( 3 a )$$

$$TP 2 \geq 85 \qquad ( 4 a )$$

Inequalities (3) and (4) may be replaced with inequalities (3b) and (4b) below:

$$9 \leq RS 2 \leq 60 \qquad ( 3 b )$$

$$TP 2 \geq 90 \qquad ( 4 b )$$

The following inequality (5) or (6) may be satisfied:

$$IoS / IoP \leq 0.2 \qquad ( 5 )$$

$$IoS / IoP \geq 5. \qquad ( 6 )$$

where IoP is a light intensity of the polarized light polarized in the first direction (P-polarized light) emitted from the polarization beam splitting unit 13, and IoS is a light intensity of the polarized light polarized in the second direction (S-polarized light) emitted from the polarization beam splitting unit 13.

In a case where IoS/IoP becomes higher than the upper limit of inequality (5) or lower than the lower limit of inequality (6), the amount of unnecessary light emitted from the polarization beam splitting unit 13 increases, and the light utilization efficiency reduces.

Inequalities (5) and (6) may be replaced with inequalities (5a) and (6a) below:

$$IoS / IoP \leq 0 \text{.15} \qquad ( 5 a )$$

$$IoS / IoP \geq 6.5 \qquad ( 6 a )$$

Inequalities (5) and (6) may be replaced with inequalities (5b) and (6b) below:

$$IoS / IoP \leq 0 \text{.10} \qquad ( 5 b )$$

$$IoS / IoP \geq 10.0 \qquad ( 6 b )$$

The following inequalities (7) and (8) may be satisfied:

$$TP 3 \geq 75 \qquad ( 7 )$$

$$RS 3 \geq 75 \qquad ( 8 )$$

where TP3 is a transmittance (%) of the dominant wavelength of polarized light polarized in the first direction (P-polarized light) on the third optical surface 13c, and RS3 is a reflectance (%) of the dominant wavelength of polarized light polarized in the second direction (S-polarized light) on the third optical surface 13c.

In a case where TP3 becomes lower than the lower limit of inequality (7) or in a case where RS3 becomes lower than the lower limit of inequality (8), the light beam L1c emitted as unnecessary polarized light increases and the light utilization efficiency reduces.

Inequalities (7) and (8) may be replaced with inequalities (7a) and (8a) below:

$$TP 3 \geq 85 \qquad ( 7 a )$$

$$RS 3 \geq 85 \qquad ( 8 a )$$

Inequalities (7) and (8) may be replaced with inequalities (7b) and (8b) below:

$$TP 3 \geq 90 \qquad ( 7 b )$$

$$RS 3 \geq 90 \qquad ( 8 b )$$

The following inequality (9) may be satisfied:

$$RP 4 \geq 75 \qquad ( 9 )$$

where RP4 is a reflectance (%) of the dominant wavelength of polarized light polarized in the first direction (P-polarized light) on the fourth optical surface 13d.

In a case where RP4 becomes lower than the lower limit of inequality (9), it reduces the amount of light emitted from the light beam L1d and reduces the light utilization efficiency.

Inequality (9) may be replaced with inequality (9a) below:

$$RP 4 \geq 85 \qquad ( 9 a )$$

Inequality (9) may be replaced with inequality (9b) below:

$$RP 4 \geq 90 \qquad ( 9 b )$$

The following inequality (10) may be satisfied:

$$0.3 \leq IiS / IiP \leq 0.7 \qquad ( 10 )$$

where IiP is a light intensity of the polarized light polarized in the first direction (P-polarized light) incident on the polarization beam splitting unit 13, and IiS is a light intensity of the polarized light polarized in the second direction (S-polarized light) incident on the polarization beam splitting unit 13.

In a case where IiS/IiP becomes higher than the upper limit or lower than the lower limit of inequality (10), a light amount distribution of the light beam emitted from the polarization beam splitting unit 13 becomes non-uniform.

Inequality (10) may be replaced with inequality (10a) below:

$$0.35 \leq IiS / IiP \leq 0.65 \qquad ( 10 a )$$

Inequality (10) may be replaced with inequality (10b) below:

$$0.4 \leq IiS / IiP \leq 0.60 \qquad ( 10 b )$$

The following inequality (11) may be satisfied:

$$80 / n \leq TP 1 \leq 320 / n \qquad ( 11 )$$

where n (n=4 in this example) is the number of optical surfaces in the polarization beam splitting unit 13.

In a case where TP1 becomes higher than the upper limit of inequality (11), the relative light intensity of the light beam L1a increases, and the light amount distribution of the light beam emitted from the polarization beam splitting unit 13 becomes non-uniform. On the other hand, in a case where TP1 becomes lower than the lower limit of inequality (11), the relative light intensity of light beam L1a reduces and the light amount distribution of the light beam emitted from the polarization beam splitting unit 13 becomes non-uniform.

Inequality (11) may be replaced with inequality (11a) below:

$$100 / n \leq TP 1 \leq 300 / n \qquad ( 11 a )$$

Inequality (11) may be replaced with inequality (11b) below:

$$140 / n \leq TP 1 \leq 260 / n \qquad ( 11 b )$$

The following inequality (12) may be satisfied:

$$80 / n \leq RS 2 \leq 320 / n \qquad ( 12 )$$

In a case where RS2 is higher than the upper limit of inequality (12), the relative light intensity of light beam L1b increases, and the light amount distribution of the light beam emitted from the polarization beam splitting unit 13 becomes non-uniform. On the other hand, in a case where RS2 is lower than the lower limit of inequality (12), the relative light intensity of light beam L1b reduces, and the light amount distribution of the light beam emitted from the polarization beam splitting unit 13 becomes non-uniform.

Inequality (12) may be replaced with inequality (12a) below:

$$100 / n \leq RS 2 \leq 300 / n \qquad ( 12 a )$$

Inequality (12) may be replaced with inequality (12b) below:

140/n≤RS2≤260/n (12b)

In this example, the second optical surface 13b may include a plurality of dielectric films. The second optical surface 13b is made, for example, by alternately stacking 14 layers of Al₂O₃ (n=1.62, λ=550 nm) and 14 layers of SiO₂ (n=1.46, λ=550 nm). The plurality of dielectric films included in the second optical surface 13b may comprise at least five dielectric films. The following inequalities (13) and (14) may be satisfied:

$$nG < nH 2 < 1.2 \times nG \qquad ( 13 )$$

$$0.8 \times nG < nL 2 < nG \qquad ( 14 )$$

where nG is a refractive index of a waveguide portion of the polarization beam splitting unit 13, nH2 is a refractive index of the at least five dielectric films with the highest refractive index (Al₂O₃ in this example) on the second optical surface 13b, and nL2 is a refractive index of the at least five dielectric films with the lowest refractive index (SiO₂ in this example) on the second optical surface 13b.

In a case where nH2 becomes higher than the upper limit or lower than the lower limit of inequality (13) or in a case where nL2 becomes higher than the upper limit or lower than the lower limit of inequality (14), the desired film characteristics cannot be obtained.

Inequalities (13) and (14) may be replaced with inequalities (13a) and (14a) below:

$$nG < nH 2 < 1.15 \times nG \qquad ( 13 a )$$

$$0.85 \times nG < nL 2 < nG \qquad ( 14 a )$$

Inequalities (13) and (14) may be replaced with inequalities (13b) and (14b) below:

$$nG < nH 2 < 1.10 \times nG \qquad ( 13 b )$$

$$0.9 \times nG < nL 2 < nG \qquad ( 14 b )$$

In this example, the first optical surface 13a may include a plurality of dielectric films. For example, the first optical surface 13a is made by alternately stacking 21 layers of TiO₂ (n=2.39, λ=550 nm) and 20 layers of Al₂O₃ (n=1.62, λ=550 nm). The first optical surface 13a may include at least five layers. The following inequalities (15) and (16) may be satisfied:

$$2. < nH 1 < 3. \qquad ( 15 )$$

$$1.4 < nL 1 < 2.0 \qquad ( 16 )$$

where nH1 is a refractive index of the dielectric film with the highest refractive index (Al₂O₃ in this example) among the at least five layers on the first optical surface 13a.

In a case where nH1 or nL1 becomes higher than the upper limit or lower than the lower limit of inequality (15) or (16), the desired film characteristics cannot be obtained.

Inequalities (15) and (16) may be replaced with inequalities (15a) and (16a) below:

$$2.1 < nH 1 < 2. 8 \qquad ( 15 a )$$

$$1.45 < nL 1 < 1.8 \qquad ( 16 a )$$

Inequalities (15) and (16) may be replaced with inequalities (15b) and (16b) below:

$$2.2 < nH 1 < 2.6 \qquad ( 15 b )$$

$$1.5 < nL 1 < 1.7 \qquad ( 16 b )$$

The following inequality (17) may be satisfied:

$$30 \leq θ \leq 60 \qquad ( 17 )$$

where θ (°) is an absolute value of an angle between the optical axis O1 of the optical system 12 and the first optical surface 13a, as illustrated in FIG. 1.

In a case where θ becomes lower than the lower limit or higher than the upper limit of inequality (17), a light amount totally reflected by the side surface of the waveguide portion of the polarization beam splitting unit 13 increases, and the light utilization efficiency reduces.

Inequality (17) may be replaced with inequality (17a) below:

$$35 \leq θ \leq 55 \qquad ( 17 a )$$

Inequality (17) may be replaced with inequality (17b) below:

$$40 \leq θ \leq 50 \qquad ( 17 b )$$

The third optical surface 13c is formed, for example, by alternating stacking 22 layers of SiO₂ (n=1.46, λ=550 nm) and 21 layers of Y₂O₃ (n=1.80, λ=550 nm).

The fourth optical surface 13d may be formed from a metal film. The fourth optical surface 13d may be formed from one layer of Ag (silver). This allows for high reflectance of P-polarized light in the visible range.

### Example 2

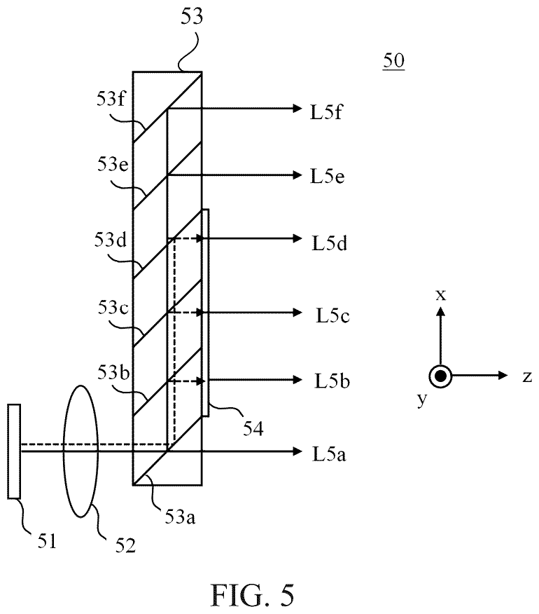

Referring now to FIG. 5, a description will be given of a light source apparatus 50 according to Example 2 of the present disclosure. FIG. 5 is a structural diagram of the light source apparatus 50. The light source apparatus 50 includes a light source 51, an optical system 52, a polarization beam splitting unit 53, and a half-wave plate (phase plate) 54.

The polarization beam splitting unit 53 has, in order from the incident portion of light from the light source 51, a first optical surface 53a, a second optical surface 53b, fifth optical surface 53c, a third optical surface 53d, a sixth optical surface 53e, and a fourth optical surface 53f.

The first optical surface 53a has the characteristic of transmitting 33.3% of P-polarized light and reflecting 100% of S-polarized light. The second optical surface 53b has the characteristic of transmitting 100% of P-polarized light and reflecting 33.3% of S-polarized light. The fifth optical surface 53c has the characteristic of transmitting 100% of P-polarized light and reflecting 50.0% of S-polarized light. The third optical surface 53d has the characteristic of transmitting 100% of P-polarized light and reflecting 100% of S-polarized light. The sixth optical surface 53e has the characteristic of reflecting 50.0% of P-polarized light. The fourth optical surface 53f has the characteristic of reflecting 100% of P-polarized light.

A light beam incident on the polarization beam splitting unit 53 is split into a plurality of light beams L5a, L5b, L5c, L5d, L5e, and L5f, which are emitted as predetermined polarized light. The light beams La, L5e, and L5f are emitted as P-polarized light. The light beams L5b, L5c, and L5d are emitted as S-polarized light and are converted into P-polarized light by the half-wave plate 54. The light is emitted from the light source apparatus 50 as P-polarized light that has been magnified by six times.

### Example 3

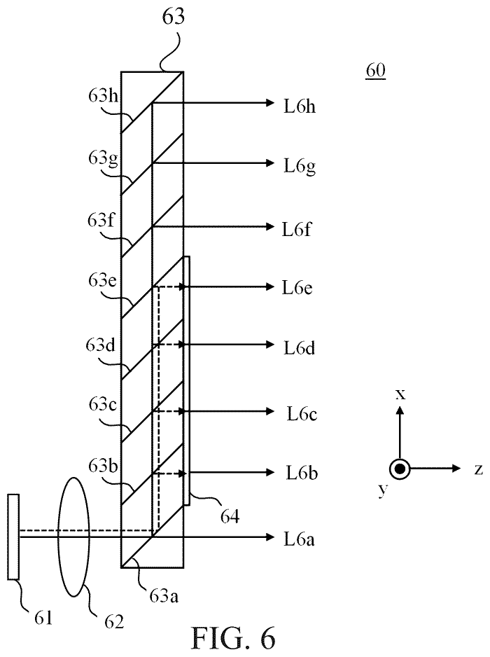

Referring now to FIG. 6, a description will be given of a light source apparatus 60 according to Example 3 of the present disclosure. FIG. 6 is a structural diagram of the light source apparatus 60. The light source apparatus 60 includes a light source 61, an optical system 62, a polarization beam splitting unit 63, and a half-wave plate (phase plate) 64.

The polarization beam splitting unit 63 has, in order from the light incident portion from the light source 61, a first optical surface 63a, a second optical surface 63b, a fifth optical surface 63c, a sixth optical surface 63d, a third optical surface 63e, a seventh optical surface 63f, an eighth optical surface 63g, and a fourth optical surface 63h.

The first optical surface 63a has the characteristic of transmitting 25.0% of P-polarized light and reflecting 100% of S-polarized light. The second optical surface 63b has the characteristic of transmitting 100% of P-polarized light and reflecting 25.0% of S-polarized light. The fifth optical surface 63c has the characteristic of transmitting 100% of P-polarized light and reflecting 33.3% of S-polarized light. The sixth optical surface 63d has the characteristic of transmitting 100% of P-polarized light and reflecting 50.0% of S-polarized light.

The third optical surface 63e has the characteristic of transmitting 100% of P-polarized light and reflecting 100% of S-polarized light.

The seventh optical surface 63f has the characteristic of reflecting 33.3% of P-polarized light. The eighth optical surface 63g has the characteristic of reflecting 50% of P-polarized light. The fourth optical surface 63h has the characteristic of reflecting 100% of P-polarized light.

The light beam incident on the polarization beam splitting unit 63 is split into a plurality of light beams L6a, L6b, L6c, L6d, L6e, L6f, L6g, and L6h, which are emitted as predetermined polarized light. The light beams L6a, L6f, L6g, and L6h are emitted as P-polarized light. The light beams L6b, L6c, L6d, and L6e are emitted as S-polarized light and are polarization-converted into P-polarized light by the half-wave plate 64. The light is emitted from the light source apparatus 60 as P-polarized light that has been magnified by eight times.

### Example 4

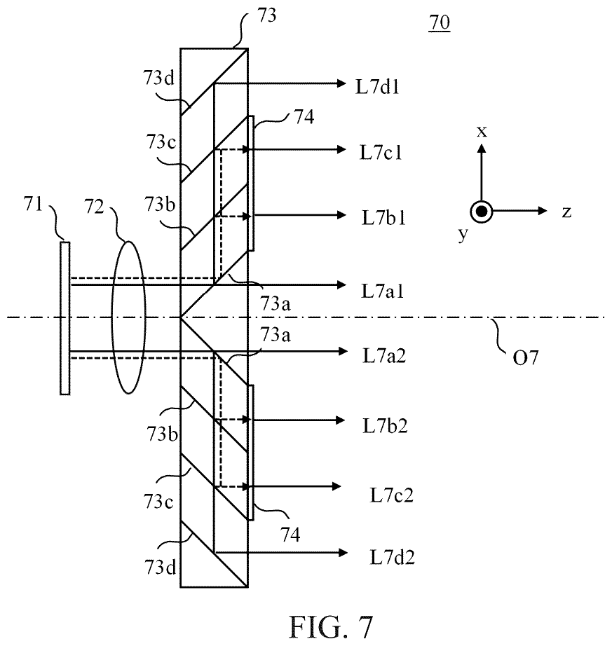

Referring now to FIG. 7, a description will be given of a light source apparatus 70 according to Example 4 of the present disclosure. FIG. 7 is a structural diagram of the light source apparatus 70. The light source apparatus 70 includes a light source 71, an optical system 72, a polarization beam splitting unit 73, and a half-wave plate (phase plate) 74.

The polarization beam splitting unit 73 is symmetrical with respect to the optical axis O7. The polarization beam splitting unit 73 has, in order from the light incident portion from the light source 71, a first optical surface 73a, a second optical surface 73b, a third optical surface 73c, and a fourth optical surface 73d. The first optical surface 73a has the characteristic of transmitting 50% of P-polarized light and reflecting 100% of S-polarized light. The second optical surface 73b has the characteristic of transmitting 100% of P-polarized light and reflecting 50% of S-polarized light. The third optical surface 73c has the characteristic of transmitting 100% of P-polarized light and reflecting 100% of S-polarized light. The fourth optical surface 73d has the characteristic of reflecting 100% of P-polarized light.

Of the light beams incident on the polarization beam splitting unit 73, the light beam in the +x direction from the optical axis O7 is split into a plurality of light beams (first light beams) L7a1, L7b1, L7cl, and L7d1. Of the light beams incident on the polarization beam splitting unit 73, the light beam in the −x direction from the optical axis O7 is split into a plurality of light beams (second light beams) L7a2, L7b2, L7c2, and L7d2.

The light beams L7a1, L7d1, L7a2, and L7d2 are emitted as P-polarized light, while the light beams L7b1, L7c1, L7b2, and L7c2 are emitted as S-polarized light and are converted into P-polarized light by the half-wave plate 74. The light is emitted from the light source apparatus 70 as P-polarized light that has been magnified by three times.

### Example 5

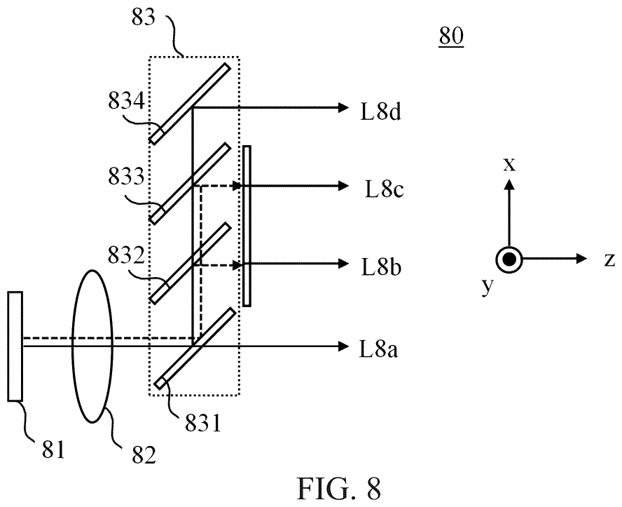

Referring now to FIG. 8, a description will be given of a light source apparatus 80 according to Example 5 of the present disclosure. FIG. 8 is a structural diagram of the light source apparatus 80. The light source apparatus 80 includes a light source 81, an optical system 82, a polarization beam splitting unit 83, and a half-wave plate (phase plate) 84.

The polarization beam splitting unit 83 includes, in order from the incident portion of light from the light source 81, a first substrate 831, a second substrate 832, a third substrate 833, and a fourth substrate 834. The incident surface of the first substrate 831 has the characteristic of transmitting 50% of P-polarized light and reflecting 100% of S-polarized light. The incident surface of the second substrate 832 has the characteristic of transmitting 100% of P-polarized light and reflecting 50% of S-polarized light. The incident surface of the third substrate 833 has the characteristic of transmitting 100% of P-polarized light and reflecting 100% of S-polarized light. The incident surface of the fourth substrate 834 has the characteristic of reflecting 100% of P-polarized light. An antireflection film (coating) is formed on the exit surfaces of the first substrate 831, second substrate 832, third substrate 833, and fourth substrate 834.

The light beam incident on the polarization beam splitting unit 83 is split into a plurality of light beams L8a, L8b, L8c, and L8d, and emitted as predetermined polarized light. The light beams L8a and L8d are emitted as P-polarized light. The light beams L8b and L8c are emitted as S-polarized light and converted into P-polarized light by the half-wave plate 84. The light is then emitted from the light source apparatus 80 as P-polarized light that has been magnified by four times.

The following inequality (18) may be satisfied:

$$di \leq 1. ( i = 1 , 2 , 3 ) \qquad ( 18 )$$

where di (mm) is a thickness of the i-th substrate.

In a case where di is higher than the upper limit of inequality (18), it generates astigmatism and degrades image quality.

Inequality (18) may be replaced with inequality (18a) below:

$$di \leq 0.7 ( i = 1 , 2 , 3 ) \qquad ( 18 a )$$

Inequality (18) may be replaced with inequality (18b) below:

$$di \leq 0.5 ( i = 1 , 2 , 3 ) \qquad ( 18 b )$$

Each example can provide a light source apparatus, a display apparatus, and a polarization beam splitting apparatus, each of which has improved light utilization efficiency.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012524, filed on Jan. 29, 2025, which is hereby incorporated by reference herein in its entirety.

What is claimed is:

1. A polarization beam splitting apparatus configured to split light from a light source and emit a plurality of polarized lights, the polarization beam splitting apparatus comprising:
a plurality of optical surfaces including a first optical surface, a second optical surface, and a third optical surface,
wherein the first optical surface is disposed closer to an incident portion of the light on the polarization beam splitting apparatus than the second optical surface,
wherein the second optical surface is disposed closer to the incident portion than the third optical surface, and
wherein the following inequalities are satisfied:
$$5 \leq TP 1 \leq 75$$
$$RS 1 \geq 75$$
where TP1 is a transmittance (%) of a dominant wavelength of polarized light polarized in a first direction on the first optical surface, and RS1 is a reflectance (%) of the dominant wavelength of polarized light polarized in a second direction on the first optical surface.

2. A light source apparatus comprising:
a light source; and
the polarization beam splitting apparatus of claim 1.

3. The light source apparatus according to claim 2, wherein the following inequalities are satisfied:
$$TP 2 \geq 75$$
$$5 \leq RS 2 \leq 75$$
where TP2 is a transmittance (%) of the dominant wavelength of the polarized light polarized in the first direction on the second optical surface, and RS2 is a reflectance (%) of the dominant wavelength of the polarized light polarized in the second direction on the second optical surface.

4. The light source apparatus according to claim 2, wherein the following inequality is satisfied:
$$IoS / IoP \leq 0.2 or IoS / IoP \geq 5.$$
where IoP is a light intensity of the polarized light polarized in the first direction emitted from the polarization beam splitting apparatus, and IoS is a light intensity of the polarized light polarized in the second direction emitted from the polarization beam splitting apparatus.

5. The light source apparatus according to claim 2, wherein the following inequalities are satisfied:
$$TP 3 \geq 75$$
$$RS 3 \geq 75$$
where TP3 is a transmittance (%) of the dominant wavelength of the polarized light polarized in the first direction on the third optical surface, and RS3 is a reflectance (%) of the dominant wavelength of the polarized light polarized in the second direction on the third optical surface.

6. The light source apparatus according to claim 2, wherein the first optical surface is a first polarizing mirror,
wherein the second optical surface is a second polarizing mirror, and
wherein the third optical surface is a polarization beam splitter.

7. The light source apparatus according to claim 2, wherein the polarization beam splitting apparatus has a fourth optical surface,
wherein the third optical surface is disposed closer to the incident portion than the fourth optical surface, and
wherein the following inequality is satisfied:
$$RP 4 \geq 75$$
where RP4 is a reflectance (%) of the dominant wavelength of the polarized light polarized in the first direction on the fourth optical surface.

8. The light source apparatus according to claim 7, wherein the fourth optical surface is a mirror.

9. The light source apparatus according to claim 2, wherein the following inequality is satisfied:
$$0.3 \leq IiS / IiP \leq 0.7$$
where IiP is a light intensity of the polarized light polarized in the first direction incident on the polarization beam splitting apparatus, and IiS is a light intensity of the polarized light polarized in the second direction incident on the polarization beam splitting apparatus.

10. The light source apparatus according to claim 2, further comprising a phase plate.

11. The light source apparatus according to claim 10, wherein the phase plate is disposed on an exit side of each of the second optical surface and the third optical surface.

12. The light source apparatus according to claim 2, wherein the following inequality is satisfied:
$$80 / n \leq TP 1 \leq 320 / n$$
where n is the number of optical surfaces.

13. The light source apparatus according to claim 2, wherein the following inequality is satisfied:
$$80 / n \leq RS 2 \leq 320 / n$$
where n is the number of optical surfaces, and RS2 is a reflectance (%) of the dominant wavelength of the polarized light polarized in the second direction on the second optical surface.

14. The light source apparatus according to claim 2, wherein the second optical surface includes a plurality of dielectric films, and wherein the following inequalities are satisfied:
$$nG < nH 2 < 1.2 \times nG$$
$$0.8 \times nG < nL 2 < nG$$
where nG is a refractive index of a waveguide portion of the polarization beam splitting apparatus, nH2 is a refractive index of at least five dielectric films on the second optical surface with the highest refractive index, and nL2 is a refractive index of at least five dielectric films on the second optical surface with the lowest refractive index.

15. The light source apparatus according to claim 2, further comprising an optical system that includes a plurality of lenses.

16. The light source apparatus according to claim 15, wherein the optical system is disposed between the light source and the polarization beam splitting apparatus.

17. The light source apparatus according to claim 2, wherein the polarized light polarized in the first direction is P-polarized light, and wherein the polarized light polarized in the second direction is S-polarized light.

18. The light source apparatus according to claim 2, wherein the following inequality is satisfied:
$$100 \geq RS 1 \geq 75 .$$

19. The light source apparatus according to claim 5, wherein the following inequality is satisfied:
$$100 \geq TP 3 \geq 75$$
$$100 \geq RS 3 \geq 75 .$$

20. The light source apparatus according to claim 7, wherein the following inequality is satisfied:
$$100 \geq RP 4 \geq 75 .$$

21. A display apparatus comprising:
the light source apparatus according to claim 2; and
a light guide element.

22. The display apparatus according to claim 21, wherein the following inequality is satisfied:
$$100 \geq RS 1 \geq 75 .$$

23. The polarization beam splitting apparatus according to claim 1, wherein the following inequality is satisfied:
$$100 \geq RS 1 \geq 75 .$$

24. An illumination system comprising the light source apparatus according to claim 2, a second polarization beam splitting apparatus, and a liquid crystal panel, configured such that:
a light beam emitted from the light source is collimated and emitted as a first plurality of light beams of light polarized in the first direction by the polarization beam splitting apparatus;
the light polarized in the first direction emitted from the light source apparatus is split into a second plurality of light beams by the second polarization beam splitting apparatus and emitted, illuminating the liquid crystal panel; and
the light beam is modulated by the liquid crystal panel and passes through the second polarization beam splitting apparatus and is emitted from the illumination system.

25. The illumination system of claim 24, further comprising:
a projector that projects the light beam emitted from the illumination system onto an illumination surface.

26. The illumination system of claim 25, applied to an Augmented Reality (AR) device, a Virtual Reality (VR) device, or a Mixed Reality (MR) device configured to project onto a pupil.

27. Use of the polarization beam splitting apparatus according to claim 1 with a projector configured to project a light beam onto an illumination surface.
